(19) United States
(12) Patent Application Publication
(10) Pub. No.: US 2004/0197125 A1
(43) Pub. Date: Oct. 7, 2004

(54) Computer controlled graphic image imprinted decorative window shades and related process for printing decorative window shades

(76) Inventors: Deborah Unger, Lorena, TX (US); Kyle L. Price, Waco, TX (US)

Correspondence Address: David G. Henry, 900 Washington Avenue, P.O. Box 1470, Waco, TX, 76703-1470, US

(21) Appl. No.: 10/408,742

(22) Filed: Apr. 7, 2003

(51) Int. Cl. B41J 5/30

(52) U.S. Cl. 400/76

(57) ABSTRACT

A process and product by process involving the production of window shades with graphics printed thereon using computer-controlled, large format printers.

### BACKGROUND OF THE INVENTION

1. Field of the Invention

The present invention relates to production of items with graphical images thereon.

2. Background Information

Pull-down window shades have existed for near countless years, yet they have changed little since their inception. A window shade is, and always has been, a (usually) rectangular piece of fabric or plastic sheeting, wound about a spring loaded roller, often with a pull ring affixed to the lower, distal edge.

Rendering a window shade decorative has, to date, been a matter, principally, of choosing an attractive fabric (substrate) from which the shade is to be produced and/or treating the lower, distal edge with features such as scalloping or fringe. If one were to desire an image (artwork, for example) to appear on a window shade, one would be required to choose, as the substrate, a pre-printed fabric with a pattern or graphic already applied thereto. The only other option is to individually paint or draw the desired image onto window shade substrate on an individual basis.

Clearly, the latter option is not cost-effective and would eliminate all but hobby type involvement for producing custom-decorated window shades. The price point of a custom-painted window shade would be prohibitive in almost all contexts.

As to the first stated option, any single desired alternative to a conventional, solid color (usually white or off-white) window shade designs, involving graphics, for example, is likely to be of very limited appeal, such that sales could not support reasonable production runs of specially decorated window shades, using present methods.

Thus, window shades having artistic reproductions, graphical designs, and even school or corporate logos are simply not feasible under all but the rarest of current conditions. Clearly, single run, or very limited run production of decorative window shades is almost always cost-prohibitive.

The present impediments to producing graphically decorated window shades as just described conflicts with the desirability of having graphically decorated window shades.

For lack of a better description: window shades at present are boring. Certainly, there are alternatives to window shades, including blinds and curtains. However, window shades are almost universally less expensive than blinds and drapery. Are those who can only afford window shades to shade their windows to have no decorative options beyond the plain white or off-white window shade? The answer, made possible by the present invention, and consistent with the following objects, is no.

### SUMMARY OF THE INVENTION

It is an object of the present invention to provide an improved, aesthetically pleasing window shade produced through a novel process for producing window shades.

It is another object of the present invention to provide an improved, aesthetically pleasing window shade produced through a novel process for producing window shades which involves the computer-controlled printer application of large graphical images onto such window shades.

It is another object of the present invention to provide a process by which custom or short-run window shade designs, not possible through existing window shade manufacturing processes, and involving graphical images appearing thereon, may be cost-effectively produced.

In satisfaction of these and related objects, the present invention includes a process for producing a window shade with a graphic image imprinted thereon, and a window shade produced through such process. No window shade with a printed graphical image, nor process for creating such a window shade is known to exist.

The present process and product by process revolves around the initial generation of a digital image file which can ultimately be processed by a large format color printer to reproduce a selected graphic image (much enlarged) onto window shade substrate.

Because the present process, for the first time, allows window shade substrate to be quickly, individually, and inexpensively produced using any graphical image that can be digitally scanned, even single item production of custom window shades with a single, unique graphic is not cost-prohibitive. Images for application to window shade substrate are near infinite in character—artwork, individual photographs, college logos, and business logos are among the choices. An even more creative option for graphic selection may involve printing a reproductions of to-be-adjacent wall paper or wall treatment designs onto shades, in order to coordinate the shade with existing room decorations.

### DETAILED DESCRIPTION OF THE PREFERRED EMBODIMENT

It is clear that certain variations and substitutions of equipment and software will fall within the scope of the present invention. Nevertheless, the presently preferred embodiment and best mode for practicing the present method and producing the product-by-process described previously is exemplified as follows:

1. Unless already available in digital file format (such as is often the case with corporate or school logos, and the like, scan original art, graphic, or photo using a flatbed scanner, setting the controlling software at the maximum scanner enlargement setting, and in RGB color mode at 300 dpi resolution. Save scanned file in Tag Image File (“TIF”) format.

2. Open TIF file with a digital photo software package, such as ADOBE PHOTOSHOP or MICROSOFT PICTURE-IT.

3. Using free hand painting, or clone painting tools (such as is available in both of the stated example software packages, touch up any imperfections, dust particles, scratches, etc. The touch up is an important step in order to ensure the quality of the final print, because imperfections of the original scan will be greatly magnified in the final shade substrate printing.

4. Enlarge image sufficiently to achieve a suitably large shade size image.

5. If detail is lost in the enlargement, application of the software's image sharpening filter will often remedy the problem.

6. Convert RGB color mode to CMYK color mode in order to adjust color using color specific image masking techniques which, in turn, helps achieve color accuracy and vibrancy.

7. Save file in EPS format with JPEG preview.

8. Open QUARK XPRESS software program and make new file proportional to desired final size and within the programs 48 maximum page size.

9. Import binary EPS file into QUARK XPRESS file.

10. Set large format color printer as output destination in QUARK XPRESS.

11. Configure large format color printer with suitable ink(s) for the desired substrate (dye-based inks, UV inks, oil-based inks, and solvent based inks).

12. Load shade media roll into printer. Examples of suitable shade media include (but are not limited to):

A. Scrim Vinyl Banner (ROLAND or MAGIC brands)

B. Poly Silk Soft cloth (ROLAND brand)

C. Artist Canvas (MAGIC brand)

D. Banner cloth (ROLAND brand)

E. Premium matte vinyl (ROLAND brand)

F. Tyvek Banner (ROLAND brand)

G. Heavy duty Banner (ROLAND brand)

H. Banner Polyethylene (MAGIC brand)

I. Banner Poly propylene ( MAGIC brand)

J. Banner I BOP ( MAGIC brand)

13. Determine enlargement percentage for desired size and send to printer.

14. Set desired raster settings on printer and rasterize file.

15. Release rastered file to print.

16. Once printing is complete the media is cut loose from the printer.

17. Trim excess material with EXACTO knife and safety trim cutting ruler (or other suitable cutting method). Note: Four to five inches of material (outside of the printed image) is left at top and bottom. Top end of material, outside of the image area is adhered to a window shade roller.

18. A loop called a pocket pole is made on the bottom end which will hold a wooden or plastic slat.

Depending on the quantity of orders, the pocket pole can be made using a permanent adhesive, or heat sealer, or sewing machine.

19. Material is attached to roller using a permanent adhesive.

A non-exclusive list of examples of large format printers which may be used in the present process include the GRAND SHERPA model wide format printer from the Agfa Company, the STYLUS PRO 10000 from the Epson company, the DISPLAYMAKER XII by the ColorSpan company, and the HP 5000 wide format printer from Hewlett Packard. Discussions of the strengths, weaknesses, and capabilities of these printers, as well as operating procedures, suitable (or included) driver software and compatible graphics software, acceptable printing media, and so forth, may be found at or through contacts provided at www.wide-format-printers.org. If such site become unavailable, a web browser search including “large format printers” will readily yield such information.

Although the invention has been described with reference to specific embodiments, this description is not meant to be construed in a limited sense. Various modifications of the disclosed embodiments, as well as alternative embodiments of the inventions will become apparent to persons skilled in the art upon the reference to the description of the invention. It is, therefore, contemplated that the appended claims will cover such modifications that fall within the scope of the invention.

I claim:

1. A decorative window shade being printed indicia produced through a process comprising the steps of:
selecting window shade substrate;
selecting a large format color printer;
selecting a digital image file representative of a graphic image, said digital image file being processable by said large format color printer;
transmitting said digital image file to said large format color printer; and
actuating said large format color printer for printing said graphic image onto said shade substrate.

2. The window shade of claim 1 further comprising the step, before said selecting of said digital image file, of generating said graphical image file by scanning an existing, visually perceptible image with a optical scanner device and saving the scanned data as said graphical image file.

3. A method for producing a decorative window shade having graphical indicia comprising the steps of:
selecting window shade substrate;
selecting a large format color printer;
selecting a digital image file representative of a graphic image, said digital image file being processable by said large format color printer;
transmitting said digital image file to said large format color printer; and
actuating said large format color printer for printing said graphic image onto said shade substrate.

4. The method of claim 3 further comprising the step, before said selecting of said digital image file, of generating said graphical image file by scanning an existing, visually perceptible image with a optical scanner device and saving the scanned data as said graphical image file.
